(19) United States
(12) Patent Application Publication
(10) Pub. No.: US 2011/0225882 A1
(43) Pub. Date: Sep. 22, 2011

(54) FLORAL PACKAGING FORMED OF RENEWABLE OR BIODEGRADABLE POLYMER MATERIALS

(76) Inventor: Donald E. Weder, Highland, IL (US)

(21) Appl. No.: 13/117,523

(22) Filed: May 27, 2011

Related U.S. Application Data
(63) Continuation of application No. 12/218,718, filed on Jul. 17, 2008, now abandoned.
Application No. 12/218,718 is a continuation-in-part of application No. 11/983,365, filed on Nov. 8, 2007, now abandoned.
Application No. 11/983,365 is a continuation-in-part of application No. 12/984,985, filed on Jan. 5, 2011.
Application No. 12/984,985 is a continuation of application No. 12/849,367, filed on Aug. 3, 2010.
Application No. 12/849,367 is a continuation of application No. 12/793,399, filed on Jun. 3, 2010, now abandoned.
Application No. 12/793,399 is a continuation of application No. 12/217,731, filed on Jul. 8, 2008, now abandoned.
Application No. 12/217,731 is a continuation of application No. 11/651,763, filed on Jan. 10, 2007, now abandoned.
Application No. 11/651,763 is a continuation of application No. 11/007,146, filed on Dec. 8, 2004, now abandoned.
Application No. 11/007,146 is a continuation of application No. 10/636,521, filed on Aug. 6, 2003, now abandoned.
Application No. 10/636,521 is a continuation-in-part of application No. 10/135,334, filed on Apr. 25, 2002, now abandoned.

(51) Int. Cl. A01G 9/02; B65B 11/00

(52) U.S. Cl. 47/66.7; 53/461

(57) ABSTRACT

A method for forming floral packaging materials from biodegradable and/or renewable polymer materials is provided. Methods of utilizing such floral packaging materials are also provided.

### CROSS REFERENCE TO RELATED APPLICATIONS

This application is a continuation of U.S. Ser. No. 12/218,718, filed Jul. 17, 2008, now abandoned; which is a continuation-in-part of U.S. Ser. No. 11/983,365, filed Nov. 8, 2007, now abandoned.

This application is also a continuation-in-part of U.S. Ser. No. 12/984,985, filed Jan. 5, 2011; which is a continuation of U.S. Ser. No. 12/849,367, filed Aug. 3, 2010; which is a continuation of U.S. Ser. No. 12/793,399, filed Jun. 3, 2010, now abandoned; which is a continuation of U.S. Ser. No. 12/217,731, filed Jul. 8, 2008, now abandoned; which is a continuation of U.S. Ser. No. 11/651,763, now abandoned; which is a continuation of U.S. Ser. No. 11/007,146, filed Dec. 8, 2004, now abandoned; which is a continuation of U.S. Ser. No. 10/636,521, filed Aug. 6, 2003, now abandoned; which is a continuation-in-part of U.S. Ser. No. 10/135,334, filed Apr. 25, 2002, now abandoned.

The entire contents of each of the above-referenced patents and patent applications are hereby expressly incorporated herein by reference.

### STATEMENT REGARDING FEDERALLY SPONSORED RESEARCH OR DEVELOPMENT

Not applicable.

### BACKGROUND OF THE INVENTION

1. Field of the Invention

The presently disclosed and claimed inventive concept(s) relates to renewable or biodegradable polymer materials, and more particularly but not by way of limitation, to flower pot covers and wraps and floral grouping covers and wraps made from such polymeric materials. In one aspect, the presently disclosed and claimed inventive concept(s) relates to methods for producing flower pot covers and methods of wrapping floral groupings and flower pots with renewable or biodegradable polymer materials to provide a decorative covering for such floral groupings and flower pots.

2. Brief Description of Prior Art

Floral packaging materials for covering potted plants and floral groupings have been known in the art for many years. While the prior art methods for covering potted plants and floral groupings have been widely accepted, new and improved methods for providing floral packaging materials having improved aesthetic qualities are being sought which are less costly and more environmentally friendly. It is to such floral packaging materials and methods for producing same that the presently disclosed and claimed inventive concept(s) is directed.

### BRIEF DESCRIPTION OF THE DRAWINGS

FIG. 1 is a perspective view of a sheet of renewable/biodegradable polymer material constructed in accordance with the presently disclosed and claimed inventive concept(s).

FIG. 2 is a perspective view of the sheet of polymeric material of FIG. 1 having a bonding material disposed along one edge thereof.

FIG. 3 is a perspective view of the sheet of polymeric material of FIG. 2 having a floral grouping disposed thereon.

FIG. 4 is a perspective view of the floral grouping of FIG. 3 being wrapped with the sheet of polymeric material of FIG. 2 by one method of wrapping.

FIG. 5 is a perspective view of a decorative cover for the floral grouping formed from the sheet of polymeric material of FIG. 2 wherein the decorative cover formed from the sheet of material has a conical configuration.

FIG. 6 is a perspective view of a decorative cover formed from the sheet of polymeric material of FIG. 2 wherein a floral grouping is wrapped with the sheet of polymeric material by a second method of wrapping so that the decorative cover formed from the sheet of polymeric material has a substantially cylindrical configuration.

FIG. 7 is a perspective view of a decorative cover positioned about a flower pot wherein the decorative cover is formed from the sheet of polymeric material of FIG. 1.

FIG. 8 is a cross-sectional view of a flower pot cover former and band applicator apparatus having the sheet of polymeric material of FIG. 1 disposed above an opening of the flower pot cover former and band applicator and having a flower pot disposed above the sheet of polymeric material.

FIG. 9 is a perspective view of a preformed pot cover formed from a sheet of polymeric material similar to the sheet of polymeric material of FIG. 1.

FIG. 10 is a perspective view of the preformed pot cover of FIG. 9 having a flower pot disposed therein.

FIG. 11 is a diagrammatic, cross-sectional view of a male and female mold having a sheet of polymeric material of FIG. 1 disposed therebetween for forming the preformed pot cover of FIG. 9.

FIG. 12 is a perspective view of a floral sleeve formed from a sheet of polymeric material constructed in accordance with the presently disclosed and claimed inventive concept(s).

FIG. 13 is a perspective view of the floral sleeve of FIG. 12 disposed about a floral grouping.

FIG. 14 is a perspective view of a floral sleeve having a cinching member wherein the floral sleeve is formed from a sheet of polymeric material constructed in accordance with the presently disclosed and claimed inventive concept(s).

FIG. 15 is a perspective view of the floral sleeve of FIG. 14 disposed about a floral grouping.

FIG. 16 is a side view of a sleeve having a detachable portion wherein the sleeve is formed from a sheet of polymeric material constructed in accordance with the presently disclosed and claimed inventive concept(s).

FIG. 17 is a perspective view of the sleeve of FIG. 16 having a flower pot disposed therein.

FIG. 18 is a perspective view of a flower pot disposed in the sleeve of FIG. 16 wherein an upper portion of the sleeve has been removed to provide a decorative cover having a skirt.

### DETAILED DESCRIPTION OF THE INVENTIVE CONCEPT(S)

Before explaining at least one embodiment of the presently disclosed and claimed inventive concept(s) in detail, it is to be understood that the presently disclosed and claimed inventive concept(s) is not limited in its application to the details of construction and the arrangement of the components or steps or methodologies set forth in the following description or illustrated in the drawings. The presently disclosed and claimed inventive concept(s) is capable of other embodiments or of being practiced or carried out in various ways. Also, it is to be understood that the phraseology and terminology employed herein is for the purpose of description and should not be regarded as limiting.

The presently disclosed and claimed inventive concept(s) is related to floral packaging materials that are formed from a renewable and/or biodegradable polymer material, as well as methods of producing and using same.

The term “renewable polymer material” as used herein will be understood to refer to environmentally-friendly materials that are renewable and/or sustainable. The terms “renewable polymer material” and “sustainable polymer material” are therefore used herein interchangeably. Renewable polymer materials are known in the art and have been developed to replace petrochemical polymer materials and reduce carbon emissions. Renewable polymer materials are formed from crop or raw materials such as, but not limited to, wheat, potatoes, corn, farmed wood, plant-derived sugars or lipids, soy or castor oil, and the like. Examples of polymers formed from these crop or raw materials include, but are not limited to, starch-based polymers, Polylactic acid (PLA), cellulose, polyhydroxyalkanoates (PHA), and the like. In addition, the term “renewable polymer materials” utilized in accordance with the presently disclosed and claimed inventive concept(s) will also be understood to include copolymers of any of the above.

Particular examples of renewable polymer materials that may be utilized in accordance with the presently disclosed and claimed inventive concept(s) include, but are not limited to, a starch polymer such as MATER-BI® (Novamont, Novara, Italy); a Polylactic acid, such as NatureWorks® PLA (Nature Works/Cargill, Minneapolis, Minn.) a PHA, such as MIREL™ (Metabolix, Cambridge, Mass.); and the various materials disclosed in U.S. Pat. Nos. 5,679,421, issued to Brinton, Jr. on Oct. 21, 1997; 5,663,216, issued to Tomka on Sep. 2, 1997; 6,669,771, issued to Tokiwa et al. on Dec. 30, 2003; 6,310,171, issued to Naito et al. on Oct. 30, 2001; 5,922,379, issued to Wang on Jul. 13, 1999; and 5,705,536, issued to Tomka on Jan. 6, 1998; the contents of each of which is hereby expressly incorporated herein by reference in its entirety. However, the above-referenced materials are provided for illustrative purposes only, and it is to be understood that the presently disclosed and claimed inventive concept(s) is not limited to use of such materials, but includes any renewable polymer materials known in the art that are capable of functioning in accordance with the presently disclosed and claimed inventive concept(s).

The term “biodegradable polymer material” as used herein will be understood to refer to environmentally-friendly materials that are degradable and/or compostable. Such materials may be degradable/compostable by various living organisms or by exposure to light and/or oxygen. Therefore, the term “biodegradable polymer material”, as used herein, will be understood to include materials that are oxobiodegradable, photobiodegradable and microbial biodegradable. Such materials may also be referred to as “bioplastics” within the art, and therefore the term “bioplastic” may also be used interchangeably herein with the term “biodegradable polymer material”.

Examples of biodegradable polymer materials that may be utilized in accordance with the presently disclosed and claimed inventive concept(s) include, but are not limited to, bioplastics made with plastarch material (PSM), and polylactic acid (PLA), certain aliphatic-aromatic co-polyester compounds such as succinates and adipates, and the like. In addition, the term “biodegradable polymer materials” utilized in accordance with the presently disclosed and claimed inventive concept(s) will also be understood to include copolymers of any of the above.

The degradation products of biodegradable polymer materials utilized in accordance with the presently disclosed and claimed inventive concept(s) may be recycled or subjected to proper disposal methods, such as but not limited to, incineration or landfill disposal. If the degradation products are suitable for recycling, the biodegradable polymer material may also be described as a renewable polymer material, as described in detail herein above.

In one embodiment, the presently disclosed and claimed inventive concept(s) is related to a method for providing a decorative cover for a flower pot and/or floral grouping. The method includes providing at least one sheet of renewable/biodegradable polymer material and forming/wrapping the at least one renewable/biodegradable polymer material into a decorative covering for the flower pot and/or floral grouping.

In another embodiment, the presently disclosed and claimed inventive concept(s) is related to a method for providing a decorative cover for a flower pot and/or floral grouping that includes providing a sleeve formed of renewable/biodegradable polymer material. A floral grouping and/or flower pot is then disposed in the sleeve to provide the decorative covering for the flower pot and/or floral grouping.

In yet another embodiment, the presently disclosed and claimed inventive concept(s) is related to a method for providing a decorative covering for a flower pot utilizing a preformed decorative flower pot cover. In such method, a preformed flower pot cover formed of renewable/biodegradable polymer material is provided, and the flower pot is disposed therein to provide the decorative covering.

The renewable/biodegradable polymer material may be selected from the group consisting of starch-based polymers, Polylactic acid, cellulose, polyhydroxyalkanoates, and copolymers thereof. The sheet/sleeve/preformed flower pot cover may be provided with at least one of a color, design and decorative pattern disposed on at least a portion thereof.

Any of the sheets/sleeves/preformed flower pot covers utilized in accordance with the presently disclosed and claimed inventive concept(s) may be provided with a bonding material disposed upon a portion thereof to aid in forming the sheet or in holding the sleeve/preformed flower pot cover about the flower pot and/or floral grouping. Alternatively, the methods of the presently disclosed and claimed inventive concept(s) may further include the step of securing the decorative covering about the flower pot and/or floral grouping via a banding element.

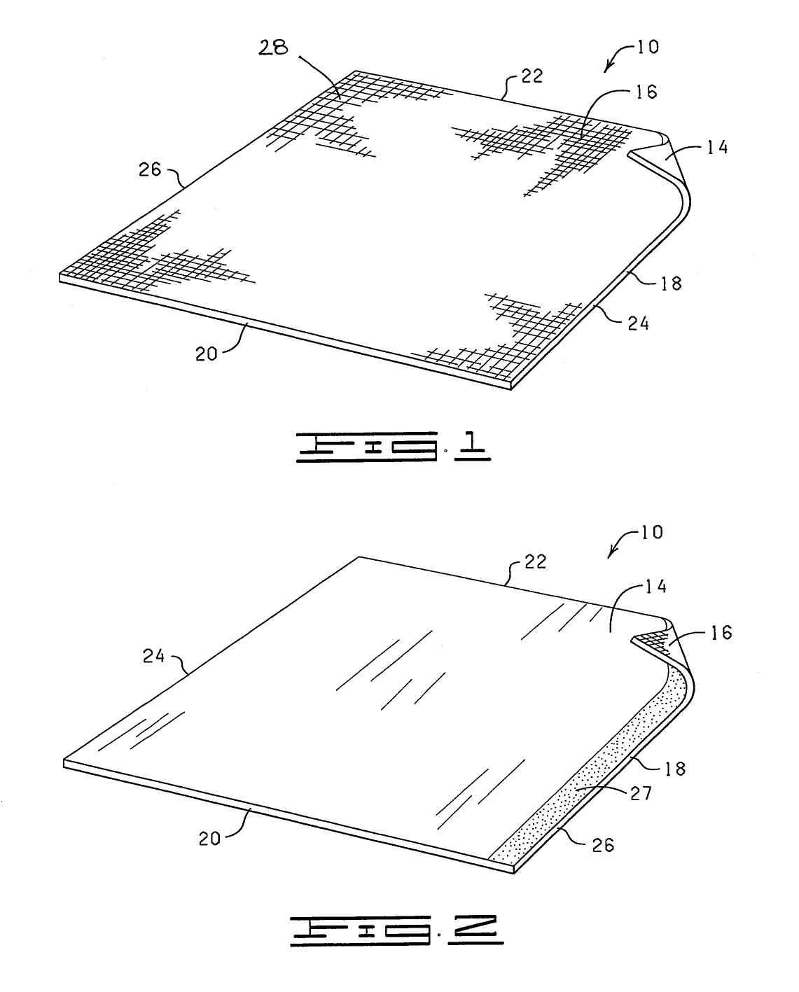

Referring now to FIGS. 1 and 2, designated generally by the reference numeral 10 is a sheet of material constructed of a renewable/biodegradable polymeric material. The sheet of renewable/biodegradable polymeric material 10 has an upper surface 14, a lower surface 16, and an outer peripheral edge 18. The outer peripheral edge 18 of the sheet of polymeric material 10 comprises a first side 20, a second side 22, a third side 24, and a fourth side 26. A bonding material 27 (FIG. 2) may be disposed on at least a portion of one or both of the upper and lower surfaces 14 and 16, respectively, of the sheet of material 10, such as the upper surface 14 thereof as shown and as further illustrated in U.S. Pat. No. 5,181,364, entitled “WRAPPING A FLORAL GROUPING WITH SHEETS HAVING ADHESIVE OR COHESIVE MATERIAL APPLIED THERETO”, issued to Weder on Jan. 26, 1999, the specification of which is hereby expressly incorporated herein by reference.

The sheet of material 10 may be constructed of a single layer of material or a plurality of layers of the same or different types of materials. The layers of material comprising the sheet of material 10 may be laminated together or connected together by any method known in the art. When the sheet of material 10 is formed of more than one layer of material, at least one layer of material is constructed of a renewable/biodegradable polymer material; however, such layer may be connected to another, non-renewable/non-biodegradable layer of material.

If desired, the sheet of material 10 may also be provided with at least a portion of at least one color, design and/or decorative pattern 28 disposed on at least a portion thereof. The color(s), design(s) and/or pattern(s) 28 may be disposed on the sheet of material 10 by any method known in the art, including but not limited to, printing, etching, embossing, texturing, flocking, coating, lacquering, application during extrusion, and the like. The color(s), design(s) and/or pattern(s) 28 may be applied separately or simultaneously or may be characterized totally or partially by pearlescent, translucent, transparent, iridescent, optical effect, paper like, cloth like, or other similar qualities, or may be a graphic image selected from the group consisting of a rendering of at least a portion of a masterpiece work of art, a rendering of at least a portion of a work of art of a Great Master, a rendering of at least a portion of a musical score, and combinations thereof. Each of the above-named characteristics may occur alone or in combination and may be applied to a portion of the upper surface 14 and/or a lower surface 16 of the sheet of material 10. Moreover, when the sheet of material 10 comprises two or more layers of material, each of the layers of material may vary in the combination of such characteristics.

In addition, when the sheet of material 10 is provided with two or more design(s) and/or pattern(s) 28, the design(s) and/or pattern(s) may be in register with one another or out of register with one another. Alternatively, a portion of the two or more design(s) and/or pattern(s) may be in register with one another, while another portion of the two or more design(s) and/or pattern(s) may be out of register with one another.

The term “optical effect material” as used herein is to understood to mean any material capable of changing appearance, such as perspective and/or color, as the angle of view of such material changes. Optical effect materials include, but are not limited to, iridescent materials, materials having one or more holograms and the like. Examples of floral packaging materials having a texture or appearance simulating the texture or appearance of cloth have previously been disclosed by the inventor in U.S. Pat. Nos. 5,576,089, issued Nov. 19, 1996; 5,634,318, issued Jun. 3, 1997; 5,701,720, issued Dec. 30, 1997; 5,727,362, issued Mar. 17, 1998; 5,775,057, issued Jul. 7, 1998; and 5,921,061, issued Jul. 13, 1999. The entire contents of each of the above-referenced patents are hereby expressly incorporated herein by reference.

The term “cloth-like” will be used interchangeably herein with the term “texture and/or appearance simulating the texture and/or appearance of cloth”. Examples of floral packaging materials having a texture or appearance simulating the texture or appearance of cloth have previously been disclosed by the inventor in U.S. Pat. Nos. 6,324,813, issued Dec. 4, 2001; 6,387,463, issued May 14, 2002; 6,463,717, issued Oct. 15, 2002; 6,495,248, issued Dec. 17, 2002; 6,565,958, issued May 20, 2003; 6,565,963, issued May 20, 2003; 6,579,603, issued Jun. 17, 2003; 6,598,372, issued Jul. 29, 2003; 6,702,919, issued Mar. 9, 2004; 6,706,379, issued Mar. 16, 2004; 6,708,464, issued Mar. 23, 2004; 6,715,261, issued Apr. 6, 2004; 6,720,051, issued Apr. 13, 2004; and 6,723,417, issued Apr. 20, 2004. The entire contents of each of the above-referenced patents are hereby expressly incorporated herein by reference.

The term “paper-like” will be used interchangeably herein with the term “texture and/or appearance simulating the texture and/or appearance of paper”. Examples of decorative grass having a texture or appearance simulating the texture or appearance of paper have previously been disclosed by the inventor in U.S. Pat. Nos. 6,365,251, issued Apr. 2, 2002; 6,401,430, issued Jun. 11, 2002; 6,403,207, issued Jun. 11, 2002; 6,425,224, issued Jul. 30, 2002; 6,521,307, issued Feb. 18, 2003; 6,613,409, issued Sep. 2, 2003; 6,755,006, issued Jun. 29, 2004; 6,884,484, issued Apr. 26, 2005; and 6,887,545, issued May 3, 2005. The entire contents of each of the above-referenced patents are hereby expressly incorporated herein by reference.

The term “masterpiece work of art” is defined herein as any product of one of the fine arts, such as a painting or a photograph, that is widely recognizable by the public and can generally be said to provide aesthetic satisfaction to the viewer. The term “rendering of at least a portion of a masterpiece work of art” not only includes exact reproductions of an original work but will also include reproductions and partial reproductions that resemble an original masterpiece work of art, such as a forgery or an imitation, works that contain an adoption of a general style of artistic expression that is recognizable, such as the Impressionist style of painting, and works that include alterations to a famous work, such as a negative image of a work, a change in coloration of a work, or the addition of a person, object or logo to a work. The term “works of the Great Masters” is to be understood to mean a work of art produced by an artist generally associated with at least one of the historical periods or movements. Examples of floral packaging materials produced using with such graphic images have previously been disclosed by the inventor in U.S. Pat. Nos. 6,510,650, issued Jan. 28, 2003; 6,691,457, issued Feb. 17, 2004; and 6,678,998, issued Jan. 20, 2004. The entire contents of each of the above-referenced patents are hereby expressly incorporated herein by reference.

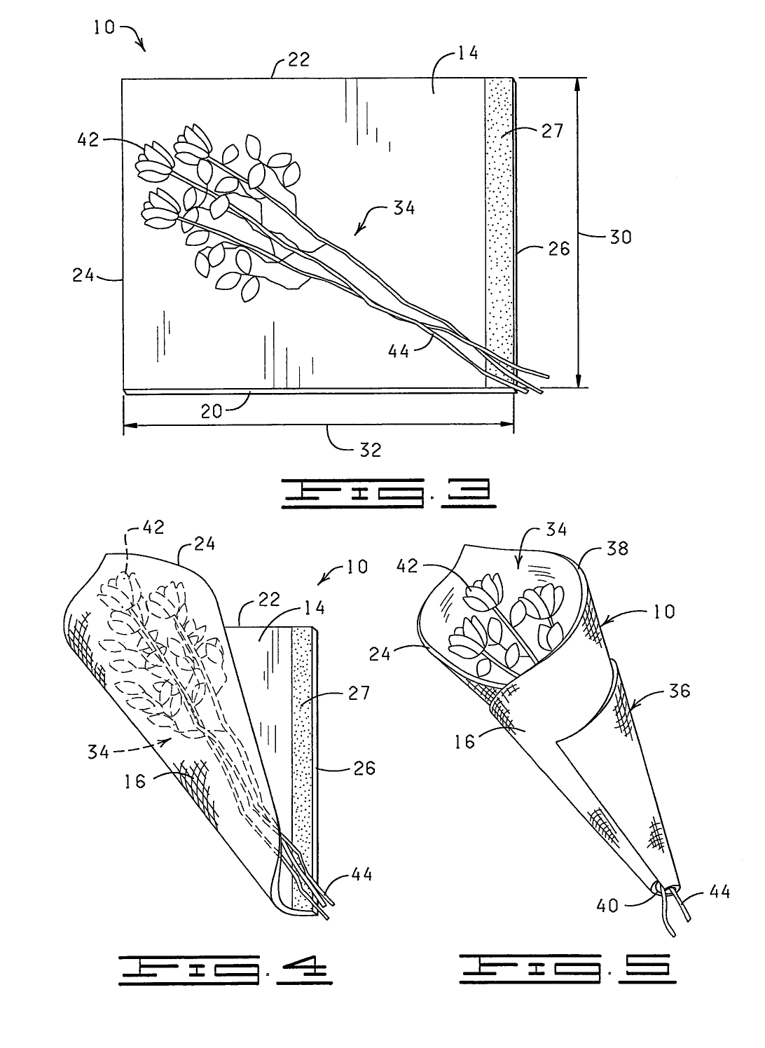

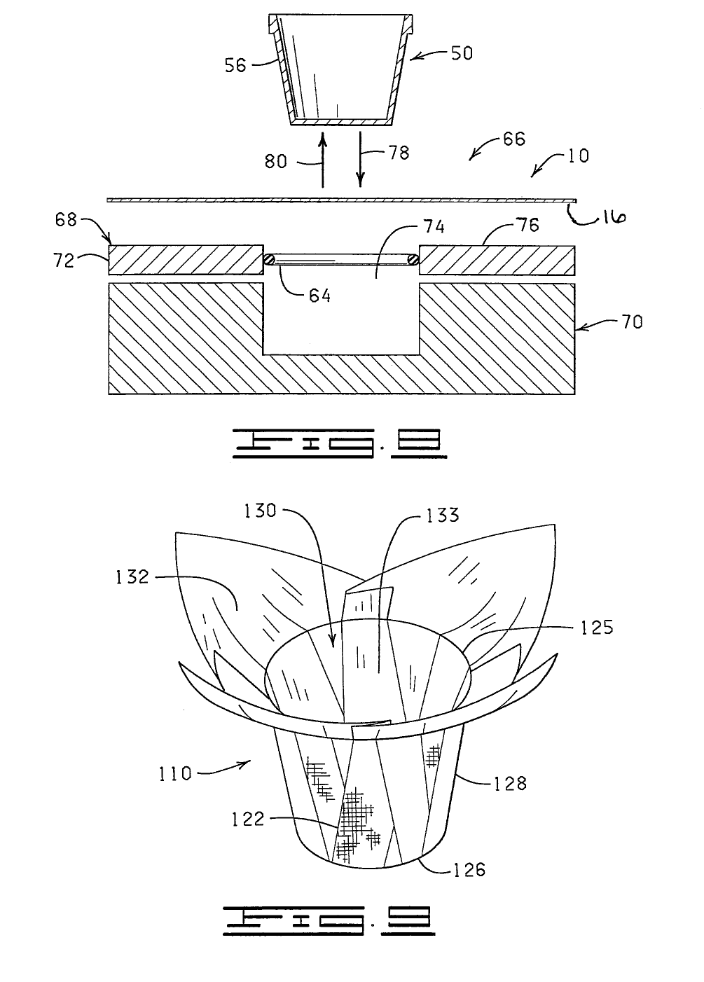

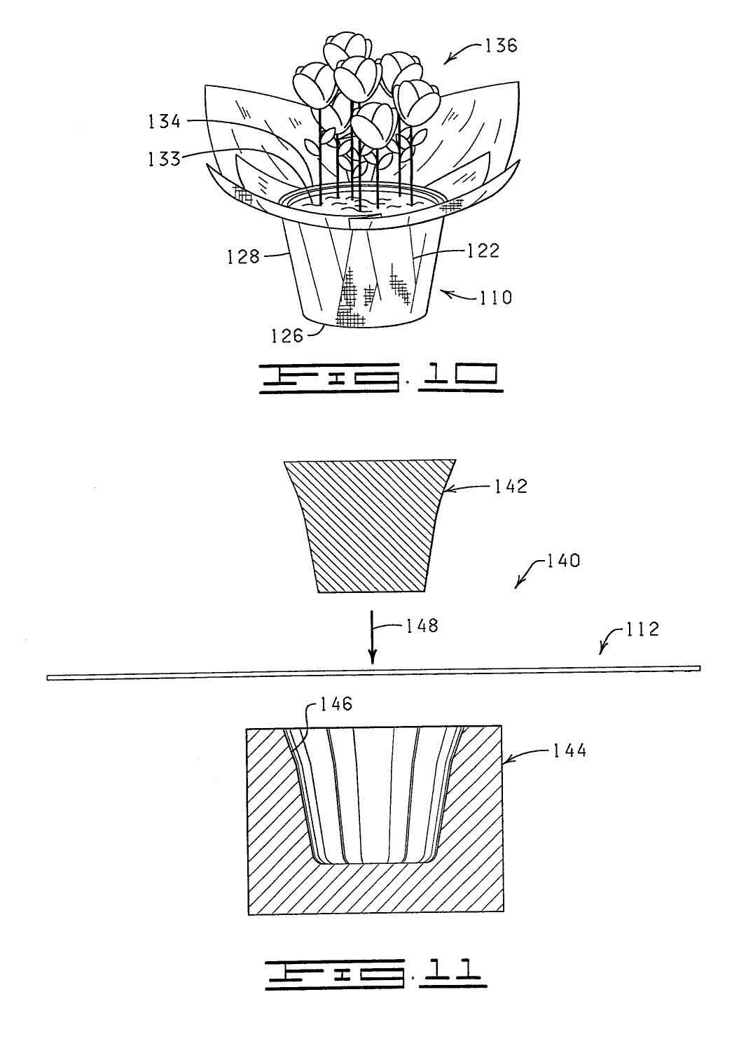

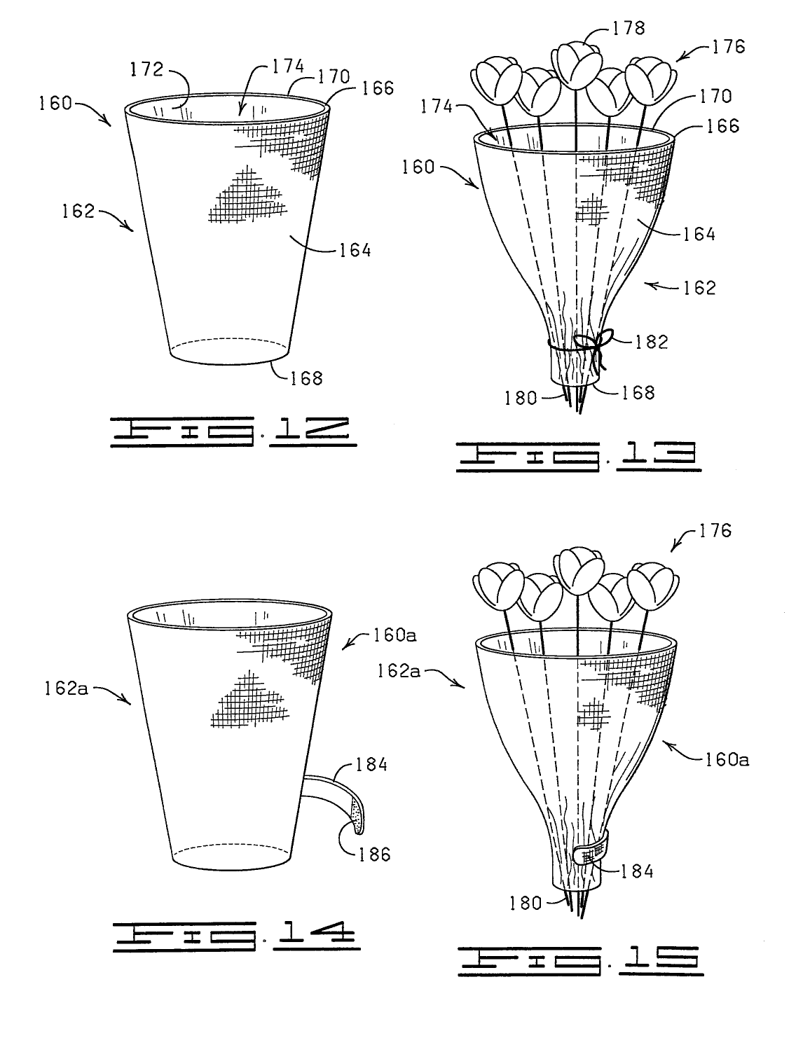

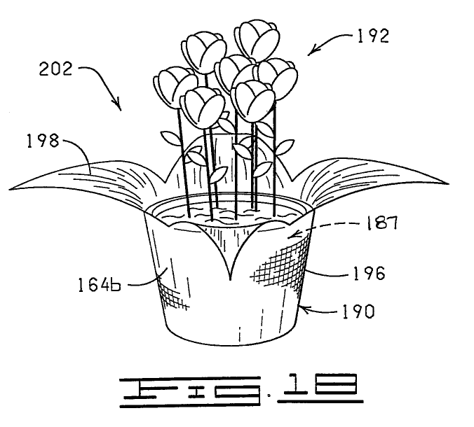

The sheet of polymeric material 10 may be employed to provide a decorative cover for a floral grouping (FIGS. 3 through 6) or a decorative cover for a flower pot (FIG. 7); or it may be employed to form a preformed flower pot cover for covering a flower pot (FIGS. 9 and 10); or it may be employed to provide a sleeve for wrapping or covering a floral grouping (FIGS. 12 through 15) or a flower pot (FIGS. 16 through 18). The use of the sheet of polymeric material 10 to form a decorative cover for a floral grouping or a flower pot, or to form a sleeve for a floral grouping or a flower pot, or to form a preformed flower pot cover will be described in more complete detail herein.

As noted above, the sheet of polymeric material 10 can be utilized to form a decorative cover for a floral grouping or a flower pot. The term “flower pot” as used herein refers to any type of container for holding a floral grouping, or a plant, or even another pot-type container. Examples of flower pots and/or pot-type containers include, but are not limited to, clay pots, wooden pots, plastic pots, pots made from natural and/or synthetic fibers, or any combination thereof. Such flower pots and/or pot-type containers are provided with a retaining space for receiving a floral grouping. The floral grouping may be disposed within the retaining space of the flower pot with a suitable growing medium described in further detail below, or other retaining medium, such as a floral foam. It will also be understood that in some cases the floral grouping, and any appropriate growing medium or other retaining medium, may be disposed in a sleeve formed from the sheet of material 10 if the sleeve is adapted to contain a medium.

“Floral grouping” as used herein will be understood to include cut fresh flowers, artificial flowers, a single flower or other fresh and/or artificial plants or other floral materials and may include other secondary plants and/or ornamentation or artificial or natural materials which add to the aesthetics of the overall floral grouping. Further, the floral grouping may comprise a growing potted plant having a root portion as well. However, it will be appreciated that the floral grouping may consist of only a single bloom or only foliage, or a botanical item (not shown), or a propagule. The term “floral grouping” may be used interchangeably herein with the term “floral arrangement”. The term “floral grouping” may also be used interchangeably herein with the terms “botanical item” and/or “propagule.”

The term “growing medium” when used herein will be understood to include any liquid, solid or gaseous material used for plant growth or for the cultivation of propagules, including organic and inorganic materials such as soil, humus, perlite, vermiculite, sand, water, and including the nutrients, fertilizers or hormones or combinations thereof required by the plants or propagules for growth.

The term “botanical item” when used herein will be understood to include a natural or artificial herbaceous or woody plant, taken singularly or in combination. The term “botanical item” also includes any portion or portions of natural or artificial herbaceous or woody plants including stems, leaves, flowers, blossoms, buds, blooms, cones, or roots, taken singly or in combination, or in groupings of such portions such as bouquets or floral groupings.

The term “propagule” when used herein will be understood to include any structure capable of being propagated or acting as an agent of reproduction including seeds, shoots, stems, runners, tubers, plants, leaves, roots or spores.

In the embodiments shown in the drawings, the sheet of polymeric material 10 is square. It will be appreciated, however, that the sheet of polymeric material 10 can be of any shape, configuration or size as long as the sheet of polymeric material 10 is sufficiently sized and shaped to wrap and encompass at least a portion of a floral grouping or a flower pot. For example, the sheet of polymeric material 10 may have a rectangular, round, oval, octagonal or asymmetrical shape. Further, multiple sheets of the polymeric material 10 may be used in a single circumstance to provide a decorative cover or sleeve for a floral grouping or a flower pot. Moreover, when multiple sheets of the polymeric material 10 are used in combination, the sheets of polymeric material 10 need not be uniform in size or shape. Finally, it will be appreciated that the sheet of polymeric material 10 shown herein is a substantially flat sheet except for any texturing, matting, embossing, flocking, application of a foamable lacquer or foamable ink, or other treatments and techniques that may be applied thereto to provide the design(s) and/or pattern(s) 28.

Any thickness or stiffness of the sheet of polymeric material 10 may be utilized in accordance with the presently disclosed and claimed inventive concept(s) as long as the sheet of polymeric material 10 can be wrapped about at least a portion of a floral grouping or a flower pot, as described herein. Generally, the sheet of polymeric material 10 will have a thickness in a range of from about 0.1 mil to about 30 mil, and more desirably a thickness in a range of from about 0.5 mil to about 2.5 mil.

As illustrated in FIG. 3, the sheet of polymeric material 10 has a width 30 extending generally between the first side 20 and the second side 22, respectively, sufficiently sized whereby the sheet of polymeric material 10 can be wrapped about and encompass at least a portion of a floral grouping or a flower pot. The sheet of polymeric material 10 has a length 32 extending generally between the third side 24 and the fourth side 26, respectively, sufficiently sized whereby the sheet of polymeric material 10 extends over a substantial portion of the floral grouping when the sheet of polymeric material 10 has been wrapped about the floral grouping in accordance with the presently disclosed and claimed inventive concept(s), as described in detail herein. The sheet of polymeric material 10 may also be wrapped about a flower pot to substantially wrap and cover the flower pot in accordance with the presently disclosed and claimed inventive concept(s), as described in greater detail herein below.

A plurality of sheets of polymeric material 10 may be connected together to form a roll as is shown in U.S. Pat. No. 5,459,976, issued to Weder et al. on Oct. 24, 1995, entitled “MATERIAL AND ADHESIVE STRIP DISPENSER”, the specification of which is hereby expressly incorporated in its entirety herein by reference.

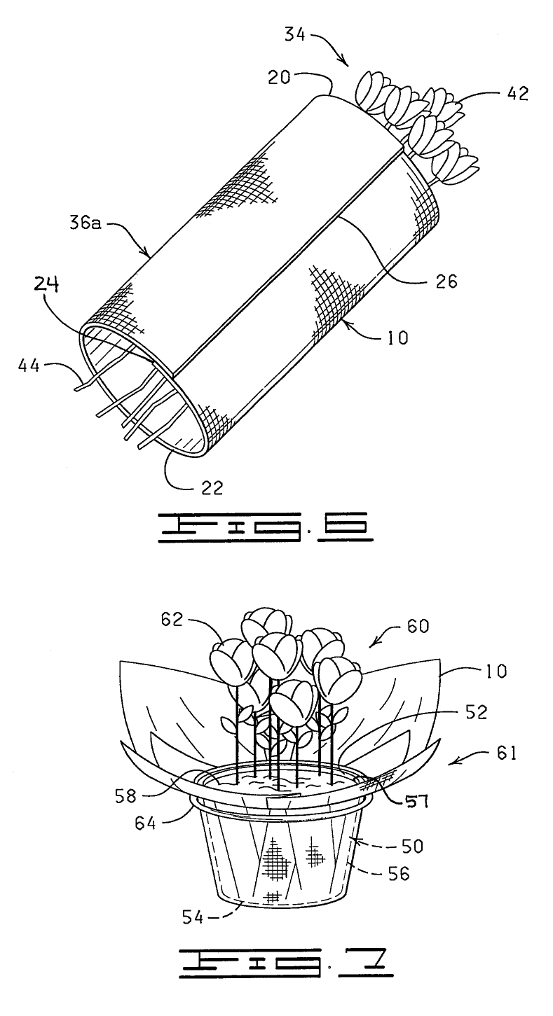

FIGS. 3 through 5 illustrate the use of the sheet of polymeric material 10 in wrapping a floral grouping 34 to provide a decorative cover 36 (FIG. 5) for the floral grouping 34, wherein the decorative cover 36 has an open upper end 38 and a lower end 40. The sheet of polymeric material 10 may optionally have the strip of bonding material 27 disposed upon at least a portion of the upper surface 14, the lower surface 16 or both, such as the strip of bonding material 27 disposed along at least a portion of the upper surface 14 of the sheet of polymeric material 10 so as to be disposed substantially adjacent the fourth side 26 thereof substantially as shown in FIGS. 3 and 4. Further, the sheet of polymeric material 10 can be provided either as an individual sheet or from a pad or roll of material.

The bonding material 27, if present, may have a backing or release strip (not shown). The backing or release strip may be left applied for a period of time to the bonding material 27 after it is disposed on a surface of the sheet of polymeric material 10 prior to its use as a wrapping material, to protect the bonding qualities of the bonding strip. In operation, an operator may dispose the sheet of polymeric material 10 on a support surface (not shown) such that the lower surface 16 of the sheet of polymeric material 10 is in contact with the support surface.

Referring more specifically to FIGS. 3 through 5, the floral grouping 34 is placed upon the upper surface 14 of the sheet of polymeric material 10 in a diagonal orientation. The floral grouping 34 has an upper bloom or foliage portion 42 and a lower stem portion 44. The sheet of polymeric material 10 is then wrapped about the floral grouping 34 by the operator (FIGS. 4 and 5), the operator overlapping a portion of the sheet of polymeric material 10 over another portion of the sheet of polymeric material 10. That is, for example, the operator places the first side 20 of the sheet of polymeric material 10 over the floral grouping 34, as shown in FIG. 4. The operator continues to roll the floral grouping 34 and the sheet of polymeric material 10 in the direction toward the second side 22 of the sheet of polymeric material 10 until the upper surface 14 near second side 22 firmly engages the lower surface 16 of the sheet of polymeric material 10, wherein the floral grouping 34 is substantially encompassed by the sheet of polymeric material 10, and wherein the bonding material 27 contacts the sheet of polymeric material 10 to provide the decorative cover 36 which substantially encompasses and surrounds a substantial portion of the floral grouping 34. FIG. 5 shows the floral grouping 34 wrapped in a conical fashion to provide the decorative cover 36 for the floral grouping 34. When the floral grouping 34 is wrapped in a conical fashion, the bloom portion 42 of the floral grouping 34 is exposed near the open upper end 38 of the decorative cover 36, and the stem portion 44 of the floral grouping 34 is exposed near the lower end 40 of the decorative cover 36.

In another embodiment, illustrated in FIG. 6, the sheet of polymeric material 10 is utilized to wrap the floral grouping 34 in a cylindrical fashion. The floral grouping 34 is disposed upon the sheet of polymeric material 10 approximately parallel to the third side 24 of the sheet of polymeric material 10. The sheet of polymeric material 10 is wrapped generally about the stem portion 44 of the floral grouping 34 to a position wherein the fourth side 26 of the sheet of polymeric material 10 generally overlaps the third side 24 of the sheet of polymeric material 10 in a cylindrical fashion. It should be noted that the sheet of polymeric material 10 may be wrapped a plurality of times about the stem portion 44 of the floral grouping 34 before the overlapping of the third side 24 and the fourth side 26 of the sheet of polymeric material 10. As before, the portion of the sheet of polymeric material 10 near the third side 24 is disposed generally adjacent another portion of the sheet of polymeric material 10, and the two adjacent portions then are brought into contact where they may be bondingly engaged, thereby securing the sheet of polymeric material 10 generally about the floral grouping 34 so as to provide a decorative cover 36a for the floral grouping 34.

In another version of the presently disclosed and claimed inventive concept(s), the sheet of polymeric material 10 may be used to wrap a flower pot or pot-type container, as noted above. Shown in FIG. 7 is a flower pot designated by the reference numeral 50 having an open upper end 52, a lower or bottom end 54, an outer peripheral surface 56, an inner peripheral surface 57, and an inner retaining space 58 within which may be disposed a growing medium. The flower pot 50 may contain a botanical item, such as a plant 60, which has an upper portion 62 comprising blooms or foliage or both.

The sheet of polymeric material 10 may be wrapped about the flower pot 50 by any one of numerous methods used to wrap sheets of material about flower pots to form decorative pot covers for flower pots, such as a decorative cover 61 disposed about the flower pot 50 illustrated in FIG. 7. The sheet of polymeric material 10 may, for example, be formed by hand about the outer peripheral surface 56 of the flower pot 50 to produce the decorative cover 61. The decorative cover 61 can then be secured about the flower pot 50, such as but not limited to, by a bonding material 64. The term “bonding material” is defined in greater detail herein after, and will be understood to include, but is not limited to, an adhesive or elastic band. The term “bonding material” as used herein will be understood to include “banding elements”.

In one embodiment, the open upper end 52 of the flower pot 50 remains substantially uncovered by the decorative cover 61 substantially as shown in FIG. 7. However, it is to be understood that the bonding material 64 may be secured about the decorative cover 61 above the upper end 52 of the flower pot 50.

Referring now to FIG. 8, a flower pot cover former and band applicator apparatus 66 for forming the sheet of polymeric material 10 into the decorative cover 61 for the flower pot 50 of FIG. 7 is illustrated. The flower pot cover former and band applicator apparatus 66 comprises a band applicator 68 and a flower pot cover former 70. The flower pot cover former and band applicator apparatus 66 has a support platform 72 with an opening 74 formed therein. A banding element 64, such as but not limited to an elastic band, is disposed circumferentially about the opening 74 in the support platform 72.

The term “banding element” as used herein will be understood to include, but not be limited to, strings, ribbons, elastic or non-elastic bands, elastic or non-elastic strings, elastic or non-elastic pieces of material, a round piece of material, a flat piece of material, a piece of paper strip, a piece of plastic strip, a piece of wire, a tie wrap, a twist tie or combinations thereof.

The lower surface 16 of the sheet of polymeric material 10 is positioned on an upper surface 76 on the support platform 72 such that the sheet of polymeric material 10 is positioned over the opening 74 in the support platform 72. The flower pot 50 is positioned above the sheet of polymeric material 10 and is moved in a direction 78 into the opening 74 of the flower pot cover former and band applicator apparatus 66. As the flower pot 50 is moved into the opening 74, the sheet of polymeric material 10 is pressed about the outer peripheral surface 56 of the flower pot 50, thereby forming the decorative cover 61 about the flower pot 50. The decorative cover 61 may then be secured about the flower pot 50 by the banding element 64. The flower pot 50 having the decorative cover 61 secured thereto is then moved in a direction 80 out of the opening 74 in the support platform 72.

The banding element 64 can be applied manually or automatically such as by the method shown in U.S. Pat. No. 5,105,599, entitled “MEANS FOR SECURING A DECORATIVE COVER ABOUT A FLOWER POT”, issued to Weder on Apr. 21, 1993 which is hereby expressly incorporated herein by reference. The banding element 64 can also be applied as a tie using a method such as described in “Single Station Covering and Fastening System”, U.S. Pat. No. 5,609,009, issued to Weder et al. on Mar. 11, 1997, the specification of which is hereby expressly incorporated herein by reference. The sheet of polymeric material 10 can also be applied automatically about the flower pot 50, for example, by methods shown in U.S. Pat. No. 4,733,521 entitled “COVER FORMING APPARATUS” issued to Weder et al. on Mar. 29, 1988, and U.S. Pat. No. 5,291,721, entitled “COVER FORMING APPARATUS HAVING A VOTING FORMING MEMBERS”, issued to Weder et al. on Mar. 8, 1994, both of which are hereby expressly incorporated herein by reference.

Instead of securing the decorative cover 61 about the flower pot 50 via the banding element 64, the decorative cover 61 formed from the sheet of polymeric material 10 may be secured to the flower pot 50 by the use of one or more bonding materials. For example, the upper surface 14 of the sheet of polymeric material 10 may have a bonding material such as the bonding material 27 disposed upon a portion thereof. When the sheet of polymeric material 10 is disposed about the flower pot 50, at least a portion of the upper surface 14 of the sheet of polymeric material 10 contacts at least a portion of at least one of the outer peripheral surface 56 and the inner peripheral surface 57 of the flower pot 50 and is thereby bonded and held about the flower pot 50 via the bonding material.

The bonding material may cover a portion of the upper surface 14 of the sheet of polymeric material 10, or the bonding material may entirely cover the upper surface 14 of the sheet of polymeric material 10. The bonding material may be disposed on the upper surface 14 of the sheet of polymeric material 10 in the form of a strip or in the form of spaced-apart spots. One method for disposing a bonding material on the sheet of polymeric material 10 is described in U.S. Pat. No. 5,111,637, entitled “Method For Wrapping A Floral Grouping”, issued to Weder, et al. on May 12, 1992, which is expressly incorporated herein by reference.

The term “bonding material” when used herein refers to an adhesive, frequently a pressure sensitive adhesive, or a cohesive or any adhesive/cohesive combination having adhesive qualities (i.e., qualities of adhesion or adhesion/cohesion, respectively) sufficient to cause the attachment of a portion of the sheet of polymeric material 10 to itself, to a floral grouping 34, or to a flower pot 50. Since the bonding material may comprise either an adhesive or an adhesive/cohesive combination, it will be appreciated that both adhesives and cohesives are known in the art, and both are commercially available. When the bonding material is a cohesive, a similar cohesive material must be placed on the adjacent surface for bondingly contacting and bondingly engaging with the cohesive material. The term “bonding material” also includes materials which are heat sealable and, in this instance, the adjacent portions of the material must be brought into contact and then heat must be applied to effect the seal. The term “bonding material” also includes materials which are sonically sealable and vibratory sealable. The term “bonding material” when used herein also includes a heat sealing lacquer or hot melt material which may be applied to the material and, in this instance, heat, sound waves, or vibrations, also must be applied to effect the sealing.

The term “bonding material” when used herein also includes any type of material or thing which can be used to effect the bonding or connecting of the two adjacent portions of the sheet of polymeric material 10 to effect the connection or bonding described herein. The term “bonding material” may also include ties, labels, bands, ribbons, strings, tapes (including single or double-sided adhesive tapes), staples or combinations thereof. Some of the bonding materials would secure the ends of the material while other bonding materials may bind the circumference of a cover, or a sleeve, or, alternatively and/or in addition, the bonding materials would secure overlapping folds in the material and/or sleeve. Another way to secure the cover and/or sleeve is to heat seal the ends of the material to another portion of the material. One way to do this is to contact the ends with an iron of sufficient heat to heat seal the material.

Alternatively, a cold seal adhesive may be utilized as the bonding material. The cold seal adhesive adheres only to a similar substrate, acting similarly as a cohesive, and binds only to itself. The cold seal adhesive, since it bonds only to a similar substrate, does not cause a residue to build up on equipment, thereby both permitting much more rapid disposition and use of such equipment to form articles and reducing labor costs. Further, since no heat is required to effect the seal, the dwell time, that is, the time for the sheet of material to form and retain the shape of an article, such as a flower pot cover or flower pot, is reduced. A cold seal adhesive binds quickly and easily with minimal pressure, and such a seal is not readily releasable. This characteristic is different from, for example, a pressure sensitive adhesive.

The term “bonding material” when used herein also includes any heat or chemically shrinkable material, and static electrical or other electrical materials, chemical welding materials, magnetic materials, mechanical or barb-type fastening materials or clamps, curl-type characteristics of the film or materials incorporated in material which can cause the material to take on certain shapes, cling films, slots, grooves, shrinkable materials and bands, curl materials, springs, and any type of welding method which may weld portions of the material to itself or to the pot, or to both the material itself and the pot.

Referring now to FIGS. 9 through 11, a decorative preformed flower pot cover 110 illustrated in FIGS. 9 and 10 is constructed from a sheet of renewable/biodegradable polymeric material 10. When the sheet of flexible material 10 is formed into the decorative preformed flower pot cover 110, a plurality of overlapping folds 122 are formed, and at least a portion of the overlapping folds 122 may be bondingly connected to adjacently disposed portions of the decorative preformed flower pot cover 110.

As shown in FIGS. 9 and 10, the decorative preformed pot cover 110 has an upper end 125, a lower end 126, and an outer peripheral surface 128. An opening 130 intersects the upper end 125, forming an inner peripheral surface 132 which defines and encompasses a retaining space 133 within which a flower pot 134 containing a floral grouping 136 may be disposed in a manner well known in the art and as shown in FIG. 10.

The decorative preformed flower pot cover 110 may be formed using a conventional mold system 140 comprising a male mold 142 and a female mold 144 having a mold cavity 146 for matingly receiving the male mold 142 (FIG. 11). The sheet of flexible material 10 is positioned between the male and female molds 142 and 144, respectively. Movement of the male mold 142 in the direction 148 and into the mold cavity 146 forces the sheet of flexible material 10 to be disposed about the portion of the male mold 142 disposed in the mold cavity 146 of the female mold 146 and thereby forms the sheet of material 10 into the preformed decorative flower pot cover 110 (FIGS. 9 and 10). Further, in accordance with the presently disclosed and claimed inventive concept(s), the decorative preformed flower pot cover 110 constructed from the materials described herein above, may have a bonding material disposed upon a portion thereof.

Methods for forming such preformed decorative pot covers are well known in the art. Two methods of forming such covers are described in U.S. Pat. No. 4,773,182, entitled “ARTICLE FORMING SYSTEM” issued to Weder et al. on Sep. 27, 1998, and U.S. Pat. No. 5,291,721, entitled “COVER FORMING APPARATUS HAVING A VOTING FORMING MEMBERS”, issued to Weder et al. on Mar. 8, 1994, each of which is expressly incorporated herein by reference. However, other methods for forming preformed decorative pot covers known in the art are also encompassed by the presently disclosed and claimed inventive concept(s).

It is also to be understood that the decorative preformed flower pot cover 110 may further be provided with a bonding material disposed on at least a portion of at least one of the inner peripheral surface 132 and outer peripheral surface 128, as described in detail herein above, for bondingly holding the preformed flower pot cover 110 about the flower pot 134. In yet another alternative, the preformed flower pot cover 110 may be secured about the flower pot 134 utilizing a banding element, as described in detail herein above.

Shown in FIG. 12 is a decorative cover designated therein by the general reference numeral 160 which comprises a flexible bag or sleeve 162 of unitary construction in accordance with the presently disclosed and claimed inventive concept(s). The sleeve 162 may be used as a decorative cover 160 for a floral grouping or a flower pot. The sleeve 162 initially comprises a flexible flat collapsed piece of material which is openable in the form of a substantially tubular structure. Such sleeves are well known in the floral industry. In accordance with the presently disclosed and claimed inventive concept(s), the sleeve 162 is constructed of a renewable/biodegradable polymeric material, as described in detail herein above. The sleeve 162 has an upper end 166, a lower end 168 and the outer peripheral surface 164. The sleeve 162 may be tapered outwardly from the lower end 168 toward a larger diameter at its upper end 166. In its flattened state the sleeve 162 generally has an overall trapezoidal or modified trapezoidal shape, and when opened is substantially frusto-conical to coniform. It will be appreciated, however, that the sleeve 162 may comprise variations on the aforementioned shapes or may comprise significantly altered shapes such as square or rectangular, wherein the sleeve 162 when opened has a cylindrical form, as long as the sleeve 162 functions in accordance with the presently disclosed and claimed inventive concept(s) in the manner described herein. The sleeve 162 (or any other sleeve disclosed herein) may have an angular or contoured shape.

The sleeve 162 has an opening 170 at the upper end 166 and may be open at the lower end 168, or closed with a bottom at the lower end 168. The sleeve 162 also has an inner peripheral surface 172 which, when the sleeve 162 is opened, defines and encompasses an inner retaining space 174. When the lower end 168 of the sleeve 162 has a closed lower end 168, a portion of the lower end 168 may be inwardly or outwardly folded to form one or more gussets (not shown) for allowing the lower portion of the inner retaining space 174 to be expandable, for example, for receiving the circular bottom of a pot or growing medium.

The sleeve 162 is generally frusto-conically shaped, but the sleeve 162 may be, by way of example but not by way of limitation, cylindrical, frusto-conical, a combination of both frusto-conical and cylindrical, or any other shape, as long as the sleeve 162 functions as described herein as noted above. Further, the sleeve 162 may comprise any shape, whether geometric, non-geometric, asymmetrical and/or fanciful as long as it functions in accordance with the presently disclosed and claimed inventive concept(s). The sleeve 162 may also be equipped with drain holes (if having a closed bottom) or side ventilation holes (not shown), or can be made from gas permeable or impermeable materials.

The material from which the sleeve 162 is constructed is the same as previously described above for the sheet of polymeric material 10. Any thickness of material may be utilized in accordance with the presently disclosed and claimed inventive concept(s) as long as the sleeve 162 may be formed as described herein and as long as the formed sleeve 162 may contain at least a portion of a flower pot or a floral grouping, as described herein. Additionally, an insulating material such as bubble film, preferable as one of two or more layers, can be utilized in order to provide additional protection for the item, such as a floral grouping, contained therein.

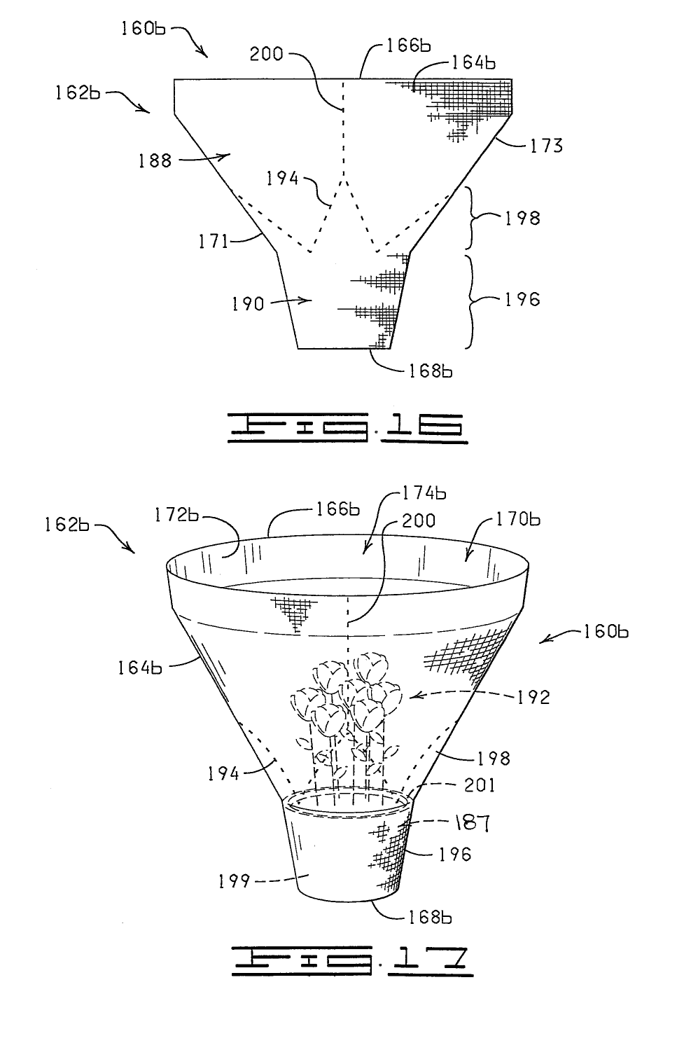

In FIG. 13, a floral grouping 176 is disposed within the inner retaining space 174 of the sleeve 162 to provide the decorative cover 160 for the floral grouping 174. Generally, at least a portion of an upper or bloom portion 178 of the floral grouping 176 is exposed adjacent the opening 170 of the sleeve 162 and at least a portion of a lower or stem portion 180 of the floral grouping 176 is substantially adjacent the lower end 168 of the sleeve 162. Either end of the sleeve 162 may be closed about the floral grouping 176. In one embodiment, a portion of the sleeve 162 is tightened and secured about a portion of the stem portion 180 of the floral grouping 176 for holding the decorative cover 160 about the floral grouping 176. For example, the sleeve 162 may be held by a banding element 182 positioned about the sleeve 162 such as is shown in FIG. 13. Other methods for binding the sleeve 162 may be employed, such as but not limited to, the bonding methods and materials described elsewhere herein. For example, as shown in FIG. 14, a decorative cover 160a is shown which comprises a sleeve 162a and a cinching tab 184 having a bonding material 186 disposed upon at least a portion of a surface thereof. The cinching tab 184 can be used to gather portions of the sleeve 162a together about the stem portion 180 of the floral grouping 176 as shown in FIG. 15 for holding the sleeve 162a tightly about the floral grouping 176 to provide the decorative cover 160a for the floral grouping 176.

Similarly, it may generally be desired to use the sleeve 162 as a decorative cover for a flower pot (not shown). The flower pot will generally contain a botanical item or plant. The flower pot can be deposited into the open sleeve 162 in a manner well known in the art, such as manually wherein the sleeve 162 is opened by hand and the flower pot deposited therein.

As noted above, a bonding material may be disposed on a portion of the sleeve 162 or any sleeve described herein to assist in holding the sleeve 162 to the flower pot when the flower pot is disposed within the sleeve 162 or to assist in closing the upper end 166 of the sleeve 162 or adhering the sleeve 162 to the flower pot after the flower pot has been disposed therein, as will be discussed in further detail below.

It will be understood that the bonding material, if present, may be disposed as a strip or block on a portion of the inner peripheral surface 172 and/or outer peripheral surface 164 of the sleeve 162. The bonding material may also be disposed upon the flower pot. Further, the bonding material may be disposed as spots of bonding material, or in any other geometric, non-geometric, asymmetric, or fanciful form, and in any pattern, including covering either the entire inner peripheral surface 172 and/or outer peripheral surface 164 of the sleeve 162 and/or the flower pot. The bonding material may be covered by a cover or release strip which can be removed prior to the use of the sleeve 162 or flower pot. The bonding material can be applied by methods known to those of ordinary skill in their art. One method for disposing a bonding material, in this case an adhesive, is described in U.S. Pat. No. 5,111,637, entitled “METHOD FOR WRAPPING A FLORAL GROUPING”, issued to Weder et al. on May 12, 1993, which is hereby expressly incorporated herein by reference.

As noted above, a bonding material may be disposed on at least a portion of the inner peripheral surface 172 of the sleeve 162 (or any other sleeve described herein), or, alternatively, the bonding material may be disposed on the outer peripheral surface of a flower pot contained within the sleeve 162, while the sleeve 162 may be free of the bonding material. In a further alternative, the bonding material may be disposed both on at least a portion of the flower pot as well as upon at least a portion of the inner peripheral surface 172 of the sleeve 162. In addition, a portion of the bonding material may also be disposed on the outer peripheral surface 164 of the sleeve 162 as well. It will be understood that the bonding material may be disposed in a solid section of bonding material. The bonding material, when present, is disposed on the sleeve 162 and/or flower pot by any method known in the art.

Certain versions of sleeves described herein may be used in combination with a preformed pot cover. For example, a preformed pot cover may be applied to the pot, then the covered pot wrapped or disposed within a sleeve. Examples of sleeves which may be used in accordance with the presently disclosed and claimed inventive concept(s) are shown in the specification of U.S. Pat. No. 5,625,979, entitled “SLEEVE HAVING A DETACHABLE PORTION FORMING A SKIRT AND METHODS”, issued to Weder on May 6, 1997, which is expressly incorporated herein by reference in its entirety. Equipment and devices for forming sleeves are commercially available, and well known in the art.

Shown in FIGS. 16-18 is another embodiment of a decorative cover 160b comprising a sleeve constructed in accordance with the presently disclosed and claimed inventive concept(s) and designated by the general reference numeral 162b. The sleeve 162b has a “detaching” element in predetermined areas for detaching a portion of the sleeve 162b. The sleeve 162b generally initially comprises a flexible flat collapsed piece of material which is openable in the form of a substantially tubular structure. The sleeve 162b is constructed of the same material and in the same way as described previously herein and may be described exactly the same as the other sleeves described herein except for the additional elements described hereinafter.

The sleeve 162b has an upper end 166b, a lower end 168b, and an outer peripheral surface 164b. The sleeve 162b has an opening 170b at the upper end 166b thereof, and the sleeve 162b may be open at the lower end 168b or closed with a bottom at the lower end 168b. In a flattened state, the sleeve 162b has a first side 171 and a second side 173. The sleeve 162b also has an inner peripheral surface 172b which, when the sleeve 162b is opened, defines and encompasses an inner retaining space 174b as shown in FIG. 17. When the lower end 168b of the sleeve 162b has a closed bottom, a portion of the lower end 168b may be inwardly folded to form one or more gussets (not shown) for permitting a circular bottom of an object such as a potted plant 187 to be disposed in the inner retaining space 174b of the lower end 168b of the sleeve 162b.

As shown in FIGS. 16 and 17, the sleeve 162b is demarcated into an upper portion 188 and a lower portion 190. The lower portion 190 of the sleeve 162b is generally sized to contain the flower pot 187. The upper portion 188 of the sleeve 162b is sized to substantially surround and encompass a plant 192 contained in the flower pot 187 disposed within the lower portion 190 of the sleeve 162b. The sleeve 162b is demarcated into the upper portion 188 and the lower portion 190 by a detaching element 194 for enabling the detachment of the upper portion 188 of the sleeve 162b from the lower portion 190 of the sleeve 162b. In the Figures, the detaching element 194 is a plurality of generally laterally-oriented or alternatingly diagonally-oriented perforations which extend circumferentially across the outer peripheral surface 164b of the sleeve 162b from the first side 171 to the second side 173. However, it is to be understood that the detaching element is not limited by the depiction shown therein; instead, any detaching element known in the art, as well as any configuration of detaching element known in the art, that allows the decorative cover to function in accordance with the presently disclosed and claimed inventive concept(s) also falls within the scope of the presently disclosed and claimed inventive concept(s).

In one embodiment, as shown in FIGS. 16 and 17, the lower portion 190 of the sleeve 162b further comprises a base portion 196 and a skirt portion 198. The base portion 196 comprises that part of the lower portion 190 which, when the flower pot 187 is placed into the lower portion 190, has an inner peripheral surface 172b which is substantially adjacent to and surrounds an outer peripheral surface 199 of the flower pot 187. The skirt portion 198 comprises that part of the lower portion 190 which extends beyond an open upper end 201 of the flower pot 187 and adjacent at least a portion of the plant 192 contained within the flower pot 187 and which is left to freely extend at an angle, inwardly or outwardly, from the base portion 196 when the upper portion 188 of the sleeve 162b is detached from the lower portion 190 of the sleeve 162b by actuation of the detaching element 194.

In the intact sleeve 162b, the skirt portion 198 comprises an upper peripheral edge congruent with the detaching element 194 which is connected to a lower peripheral edge, also congruent with the detaching element 194, of the upper portion 188 of the sleeve 162b. In FIGS. 16 and 17, the upper peripheral edge of the skirt portion 198 is congruent with a series of alternatingly diagonally-oriented lines of perforations which together form a zig-zag and comprise the detaching element 194. The upper portion 188 of the sleeve 162b may also have an additional detaching element 200 indicated as a plurality of vertical perforations for facilitating removal of the upper portion 188 and which are disposed more or less vertically therein extending between the detaching element 194 of the sleeve 162b.

The upper portion 188 of the sleeve 162b is thereby separable from the lower portion 190 of the sleeve 162b by tearing the upper portion 188 along both the detaching element 200 and the detaching element 194, thereby separating the upper portion 188 from the lower portion 190 of the sleeve 162b. The lower portion 190 of the sleeve 162b remains disposed as the base portion 196 about the flower pot 187 and as the skirt portion 198 about a portion of the plant 192, thereby forming a decorative cover 202 as shown in FIG. 18 which substantially surrounds and encompasses the flower pot 187 and at least a portion of the plant 192 contained therein.

“Detaching element” as used herein, includes any element, or combination of elements, or features, such as, but not by way of limitation, perforations, tear strips, zippers, and any other devices or elements of this nature known in the art, or any combination thereof. Therefore, while perforations are shown and described in detail herein, it will be understood that tear strips, zippers, or any other “detaching elements” known in the art, or any combination thereof, could be substituted therefor and/or used therewith.

In a general method of use of sleeve 162b as a decorative cover for a flower pot, an operator provides a sleeve 162b, and the flower pot 187 having a plant 192 disposed in a growing medium contained within the flower pot 187. The operator then disposes the flower pot 187 having the plant 192 contained therein into the sleeve 162b by opening the sleeve 162b at its upper end 166b and assuring both that the opening 170b therein is in an open condition, and that the inner peripheral surface 172b of the sleeve 162b is somewhat expanded outward as well, as shown in FIG. 17. The operator then manually or automatically disposes the flower pot 187 into the opening 170b in the sleeve 162b, the flower pot 187 being disposed generally through the upper portion 188 of the sleeve 162b into generally the lower portion 190 of the sleeve 162b, the flower pot 187 remaining in the lower portion 190 of the sleeve 162b, permitting the sleeve 162b to substantially surround and tightly encompass the flower pot 187. It will be understood that alternatively, the sleeve 162b may be provided with an extension (not shown), and the sleeve 162b may be disposed on rods or wickets, and the flower pot 187 may be disposed in the sleeve 162b either before or after the sleeve 162b has been removed from the wickets.

Changes may be made in the construction and the operation of the various components, elements and assemblies described herein or in the steps or the sequence of steps of the methods described herein without departing from the spirit and scope of the inventive concept(s) as defined in the following claims.

What is claimed is:

1. A method for providing a decorative covering for a floral grouping comprising the steps of:
providing a sheet of polymer material, wherein the polymer material is at least one of a renewable polymer material and a biodegradable polymer material, and wherein the sheet of polymer material has an upper surface and a lower surface;
providing a floral grouping having at least one of a bloom portion and a stem portion; and
wrapping the sheet of polymer material about the floral grouping to provide the decorative covering for the floral grouping.

2. The method of claim 1 wherein, in the step of providing the sheet of polymer material, the polymer material is selected from the group consisting of starch-based polymers, Polylactic acid, cellulose, polyhydroxyalkanoates, and copolymers thereof.

3. The method of claim 1 wherein, in the step of providing the sheet of polymer material, the sheet of polymer material is further characterized as having a bonding material disposed on at least a portion of at least one of the upper and lower surfaces thereof for bondingly holding the decorative covering about the floral grouping.

4. The method of claim 1, further comprising the step of securing the sheet of polymer material about the floral grouping with a banding element.

5. The method of claim 1 wherein, in the step of providing the sheet of polymer material, the sheet of polymer material is provided with at least one of a color, design and decorative pattern disposed on at least a portion thereof.

6. A method for forming a decorative covering for a floral grouping, comprising the steps of:
providing a sleeve initially comprising a flexible collapsed piece of material that is openable in the form of a substantially tubular structure, the sleeve having an upper end, a lower end, an outer peripheral surface, an inner peripheral surface and an inner retaining space, the sleeve formed of a polymer material wherein the polymer material is at least one of a renewable polymer material and a biodegradable polymer material;
providing a floral grouping having at least one of a bloom portion and a stem portion;
disposing at least a portion of the floral grouping into at least a portion of the inner retaining space of the sleeve, thereby providing a decorative covering for the floral grouping.

7. The method of claim 6 wherein, in the step of providing the sleeve, the polymer material from which the sleeve is formed is selected from the group consisting of starch-based polymers, polylactic acid, cellulose, polyhydroxyalkanoates, and copolymers thereof.

8. The method of claim 6, further comprising the step of securing the sleeve about the floral grouping via a banding element.

9. The method of claim 6 wherein, in the step of providing a floral grouping, the floral grouping is further defined as comprising a bloom portion and a stem portion, and wherein the step of disposing is further defined as disposing at least a portion of the floral grouping into at least a portion of the retaining space of the sleeve such that the bloom portion of the floral grouping is exposed adjacent the opening in the upper end of the sleeve and at least a portion of the stem portion of the floral grouping is substantially adjacent the lower end of the sleeve.

10. The method of claim 6 wherein, in the step of providing the sleeve, the lower end of the sleeve is open.

11. The method of claim 6 wherein, in the step of providing the sheet of polymer material, the sheet of polymer material is provided with at least one of a color, design and decorative pattern disposed on at least a portion thereof.

12. A method for providing a decorative covering for a flower pot, comprising the steps of:
providing a sheet of polymer material, wherein the polymer material is at least one of a renewable polymer material and a biodegradable polymer material, and wherein the sheet of polymer material has an upper surface and a lower surface;
providing a flower pot having an upper end, a lower end, an outer peripheral surface, an inner peripheral surface and an inner retaining space;
disposing the lower end of the flower pot on the upper surface of the sheet of polymer material;
forming the sheet of polymer material about the outer peripheral surface of the flower pot to provide the decorative covering.

13. The method of claim 12 wherein, in the step of providing the sheet of polymer material, the polymer material is selected from the group consisting of starch-based polymers, Polylactic acid, cellulose, polyhydroxyalkanoates, and copolymers thereof.

14. The method of claim 12 wherein, in the step of providing the sheet of polymer material, the sheet of polymer material is further characterized as having a bonding material disposed on at least a portion of at least one of the upper and lower surfaces thereof for bondingly holding the decorative covering about the flower pot.

15. The method of claim 12, further comprising the step of securing the sheet of polymer material about the flower pot with a banding element.

16. The method of claim 12 wherein, in the step of providing the sheet of polymer material, the sheet of polymer material is provided with at least one of a color, design and decorative pattern disposed on at least a portion thereof.

17. A method for providing a decorative covering for a flower pot, comprising the steps of:
providing a preformed flower pot cover formed of polymer material, wherein the polymer material is at least one of a renewable polymer material and a biodegradable polymer material, wherein the preformed flower pot cover has an open upper end, a closed lower end, an inner peripheral surface, an outer peripheral surface and an inner retaining space;
providing a flower pot having an upper end, a lower end, an outer peripheral surface and an inner peripheral surface; and
disposing the flower pot into the inner retaining space of the preformed flower pot cover to provide the decorative covering.

18. The method of claim 17 wherein, in the step of providing the preformed flower pot cover, the polymer material from which the preformed flower pot cover is formed is selected from the group consisting of starch-based polymers, Polylactic acid, cellulose, polyhydroxyalkanoates, and copolymers thereof.

19. The method of claim 17 wherein, in the step of providing the preformed flower pot cover, the preformed flower pot cover is further characterized as having a bonding material disposed on at least a portion of at least one of the inner and outer peripheral surfaces thereof for bondingly holding the preformed flower pot cover about the flower pot.

20. The method of claim 17 wherein, in the step of providing the preformed flower pot cover, the preformed flower pot cover is provided with at least one of a color, design and decorative pattern disposed on at least a portion of at least one of the inner and outer peripheral surfaces thereof.

21. A method for providing a decorative covering for a flower pot, comprising the steps of:
providing a sleeve initially comprising a flexible collapsed piece of material that is openable in the form of a substantially tubular structure, the sleeve having an upper end, a lower end, an outer peripheral surface, an inner peripheral surface and an inner retaining space, the sleeve formed of a polymer material wherein the polymer material is at least one of a renewable polymer material and a biodegradable polymer material;
providing a flower pot having an upper end, a lower end, an outer peripheral surface and an inner peripheral surface, the flower pot having a floral grouping disposed therein;
disposing the flower pot into at least a portion of the inner retaining space of the sleeve, thereby providing a decorative covering for the flower pot.

22. The method of claim 21 wherein, in the step of providing the sleeve, the polymer material from which the sleeve is formed is selected from the group consisting of starch-based polymers, polylactic acid, cellulose, polyhydroxyalkanoates, and copolymers thereof.

23. The method of claim 21, further comprising the step of securing the sleeve about the flower pot via a banding element.

24. The method of claim 21 wherein, in the step of providing the sleeve, the lower end of the sleeve is open.

25. The method of claim 21 wherein, in the step of providing the sleeve, the sleeve is provided with at least one of a color, design and decorative pattern disposed on at least a portion thereof.

26. The method of claim 21 wherein, in the step of providing the sleeve, the sleeve is further defined as comprising an upper portion and a lower portion, wherein the upper portion is detachable from the lower portion via a detaching element.

27. The method of claim 26 wherein, in the step of disposing at least a portion of the flower pot into at least a portion of the sleeve, the lower portion of the sleeve is substantially adjacent to and surrounds the outer peripheral surface of the flower pot and the upper portion of the sleeve surrounds at least a portion of the floral grouping disposed in the flower pot.

28. The method of claim 26, further comprising the step of removing the upper portion of the sleeve from the lower portion of the sleeve via the detaching element, wherein the lower portion of the sleeve remains disposed about the flower pot as the decorative covering.

29. The method of claim 28 wherein, in the step of providing the sleeve, the lower portion of the sleeve further comprises a base portion and a skirt portion, and upon removal of the upper portion of the sleeve therefrom, the lower portion of the sleeve forms the decorative covering disposed about the flower pot, wherein the base portion of the lower portion of the sleeve is substantially adjacent to and surrounds the outer peripheral surface of the flower pot and the skirt portion of the lower portion of the sleeve extends above the flower pot and is adjacent to at least a portion of the floral grouping disposed in the flower pot.
